(19) United States
(12) Patent Application Publication
(10) Pub. No.: US 2005/0076094 A1
(43) Pub. Date: Apr. 7, 2005

(54) Method and apparatus for synchronizing data between multiple memories

(76) Inventors: Takeshi Sasaki, Tokyo (JP); Masato Inoue, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/878,287

(22) Filed: Jun. 29, 2004

(30) Foreign Application Priority Data
Jun. 30, 2003 (JP) JP 2003-188402

(51) Int. Cl. G06F 15/16; G06F 15/173

(52) U.S. Cl. 709/217; 709/224

(57) ABSTRACT

A data synchronizing control apparatus helps to efficiently manage the storage of data in multiple memories. The apparatus determines the presence of a reference relationship/referenced relationship from other object data, of object data to be deleted, among a plurality of object data stored in a portable device or terminal. The apparatus then outputs to the portable device an instruction to delete the object data.

### TECHNICAL FIELD

The present invention generally relates to synchronizing data between storage systems in a computer network. More particularly, the present invention relates to updating modified data stored in a database system and in a portable terminal or device connectable via a network.

### RELATED APPLICATIONS

Applicants claim priority to Japanese Patent Application No. 2003-188402 filed Jun. 30, 2003, the content of which is incorporated herein by reference.

### BACKGROUND

Computer networks at times need to manage the storage of the same data in multiple memories. Often those memories reside in different computers across the network. When the data in one memory location is modified, the computer network may need to synchronize that modified data with the original data stored at other locations. Moreover, often one of the memory locations resides in a portable device or terminal on the network that may have limited resources compared with other terminals on the network and may be connected to the network only intermittently.

Several documents have described techniques for synchronizing data before modification with data after modification in data communication between computer terminals and portable-type terminals or devices.

For example, Japanese Unexamined Patent Application, First Publication No. 2000-137687 discloses that data on a transmitter side (computer terminal) and data on a receiver side (portable type terminal or device) are matched to each other using unique identification information. When receiving modified data and identification information corresponding to data transmitted from the transmitter, the receiver sets an after-modification attribute for the received data. The receiver also sets a before-modification attribute for data, among the data stored in the memory section, with the same identification information, matching the received data. When displaying data stored in the memory section, data with the after-modification attribute set and data with the before-modification attribute set are each displayed using identification indicating the before-modification or after-modification attributes. According to this publication, in a case where data whose after-modification attribute is set is deleted from the memory section, the before-modification attribute setting is cancelled from data that matches the data deleted whose before-modification attribute is set.

Furthermore, Japanese Unexamined Patent Application, First Publication No. 8-123713 discloses a file storage administration system that organizes data close to each other in a data storage file according to parent-child relationships between records describing individual data entities. This file storage administrating system performs insertions to and deletions from relationships and records belonging to a module, reading records into main memory by module unit. The system also reads data by record unit using relationships, by administering relationship definition files, data page files, data pages, page map files and meta map files.

In addition, in recent years, attention has been given to sharing in-house information from enterprise systems in real time by making enterprise applications mobile. By connecting together a central business database system and portable terminals, it is possible to access business data instantly, thus enabling up-to-date information to be updated and shared in real time.

In such an enterprise application, data updated offline in a portable terminal must be synchronized with various backend systems during online connection via a public packet network, LAN, wireless LAN, cradle, or the like, after encryption or compression.

In a case where a data synchronization algorithm as described above is used as a mobile engine of an enterprise application, a data synchronization process is required that considers processing capabilities and memory capacity limits, especially on the portable terminal side. For this reason, in the data administration system as described above, redundancy of transmitted data is high, and data synchronization cannot be performed efficiently.

### SUMMARY

In one aspect of the present invention, a data synchronizing control apparatus connectable to a portable terminal via a network includes a reference relationship determination device and a data deletion device. The reference relationship determination device determines whether or not object data to be deleted is referenced by other object data among a plurality of object data stored in the portable terminal. The data deletion device outputs, to the portable terminal, an instruction to delete the object data to be deleted, based on the determination result of the reference relationship determination device.

In the case where the determination result of the reference relationship determination device indicates that the object data to be deleted is not referenced by other object data, the data deletion device outputs an instruction to the portable terminal to delete the object data to be deleted. Moreover, where the determination result of the reference relationship determination device indicates that the object data to be deleted is referenced by other object data, the data deletion device sets the other object data having the reference relationship as the object to be deleted, and calls the reference relationship determination device recursively.

In another aspect, a data synchronizing control apparatus connectable to a portable terminal via a network includes a reference relationship determination device that determines whether or not object data to be deleted references other object data among a plurality of object data stored in the portable terminal. The apparatus includes a data deletion device which outputs to the portable terminal an instruction to delete the other object data that the object data to be deleted references, based on the determination result of the reference relationship determination device.

In the case where the determination result of the reference relationship determination device indicates that the object data to be deleted references no other object data, the data deletion device outputs an instruction to the portable terminal to delete the object data to be deleted. In the case where the determination result of the reference relationship determination device indicates that the object data to be deleted references other object data, the data deletion device sets the other object data having the reference relationship as the object to be deleted, and calls the reference relationship determination device recursively.

Moreover, in the case where the determination result of the reference relationship determination device indicates that the object data to be deleted references other object data, the data deletion device examines a cascade download flag, which is preset in the other object data having the reference relationship. Based on the examination result, the data deletion device sets the other object data having the reference relationship as the object to be deleted, and calls the reference relationship determination device recursively. Alternatively, the data deletion device determines whether the object data is referenced by other object data or not, and based on the examination result and determination result, sets the other object data having the reference relationship as the object to be deleted, and calls the reference relationship determination device recursively.

Moreover, in another aspect, a method for synchronizing data in a control apparatus connectable to a portable terminal via a network includes determining whether or not object data to be deleted is referenced by other object data among a plurality of object data stored in the portable terminal, and outputting an instruction to the portable terminal to delete the object data to be deleted based on the determination result. In the case where the determination result of the reference relationship indicates that the object data is not referenced by the other object data, the method includes outputting an instruction to the portable terminal to delete the object data to be deleted.

In the case where the determination result of the reference relationship indicates that the object data is referenced by the other object data, the method includes setting the other object data having the reference relationship as the object to be deleted, and recursively calling a reference relationship determination device which determines the reference relationship.

In a further aspect, a method for synchronizing data in a control apparatus connectable to a portable terminal via a network includes determining whether or not object data to be deleted references other object data among a plurality of object data stored in the portable terminal, and outputting an instruction to the portable terminal to delete the other object data which the object data to be deleted references, based on the determination result.

In the case where the determination result of the reference relationship indicates that the other object data is not referenced, the method includes outputting an instruction to the portable terminal to delete the object data to be deleted. In the case where the determination result of the reference relationship indicates that the other object data is referenced, the method includes setting the other object data having the reference relationship as the object to be deleted, and recursively calling a reference relationship determination which determines the reference relationship.

Moreover, in the case where the reference relationship determination result indicates that the other object data is referenced, the method includes examining a cascade download flag, which is preset in the other object data having the reference relationship. Based on the examination result, the method further includes setting the other object data having the reference relationship as the object to be deleted, and recursively calling a reference relationship determination device which determines the reference relationship. Alternatively, the method further includes determining whether the object data is referenced by the other object data or not, and based on the examination result and determination result, setting the other object data having the reference relationship as the object to be deleted, and recursively calling a reference relationship determination device which determines the reference relationship.

In a further aspect, a computer-readable medium stores a set of instructions for synchronizing data for a data synchronizing control apparatus connectable to a portable terminal via a network. When executed, the instructions perform stages including determining whether or not object data to be deleted is referenced by other object data among a plurality of object data stored in the portable terminal, and outputting an instruction to the portable terminal to delete the object data to be deleted based on the determination result of the reference relationship.

In the case where the determination result of the reference relationship indicates that the data is not referenced by the other object data, the stages performed include outputting an instruction to the portable terminal to delete the object data to be deleted. In the case where the reference relationship determination result indicates that the data is referenced by the other object data, the stages performed include setting the other object data having the reference relationship as the object to be deleted, and recursively determining the reference relationship.

In another aspect, a computer-readable medium stores a set of instructions for synchronizing data for a data synchronizing control apparatus connectable to a portable terminal via a network, which when executed perform stages including determining whether or not object data to be deleted references other object data among a plurality of object data stored in the portable terminal. The stages performed further include outputting an instruction to the portable terminal to delete the other object data that the object data to be deleted references based on the determination result of the reference relationship.

In the case where the determination result of the reference relationship indicates that the other object data is not referenced, the stages performed include outputting an instruction to the portable terminal to delete the object data to be deleted. In the case where the reference relationship determination result indicates that said object data is referenced by the other object data, the stages performed include setting the other object data having the reference relationship as the object to be deleted, and recursively determining the reference relationship.

Furthermore, in the case where the determination result of the reference relationship indicates that the other object data is referenced, the stages performed include examining a cascade download flag, which is preset in the other object data having the reference relationship. Based on the examination result, the stages performed further include setting the other object data having the reference relationship as the object to be deleted, and recursively determining the reference relation-ship. Alternatively, the stages performed further include determining whether the object data is referenced by the other object data or not, and based on the examination result and determination result, setting the other object data having the reference relationship as the object to be deleted, and recursively determining the reference relationship.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is a structural diagram of an enterprise server system.

FIG. 2 is a structural diagram of the functional layers of a business object 200.

FIG. 3 is a data structure diagram of the business object 200.

FIG. 4 is a data structure diagram of a synch business object.

FIG. 5 is a diagram of the data structure of the synch business object and its reference relationships.

FIG. 6 is a flow chart of a cascade download process.

FIG. 7 is a data structure diagram of a replica database 108.

FIG. 8 is a diagram of the download data structure of a mobile device 120.

FIG. 9 is a diagram of the structure of a status administration table T1.

FIG. 10 is a diagram of the structure of a status administration table T2.

FIG. 11 is a diagram of the structure of a status administration table T3.

FIG. 12 is a diagram of the structure of an administration table T4.

FIG. 13 is a flow chart of the main processes of cascade download and cascade deletion.

FIG. 14 is a flow chart of the cascade download process.

FIG. 15 is a flow chart of the cascade deletion process of a child object.

FIG. 16 is a flow chart of the cascade deletion process of a parent object.

### DETAILED DESCRIPTION

The following description refers to the accompanying drawings in which, in the absence of a contrary representation, the same numbers in different drawings represent similar elements. The implementations in the following description do not represent all implementations consistent with principles of the claimed invention. Instead, they are merely some examples of systems and methods consistent with those principles. It is to be understood that both the foregoing general description and the following detailed description are exemplary and explanatory only and are not restrictive of the invention, as claimed.

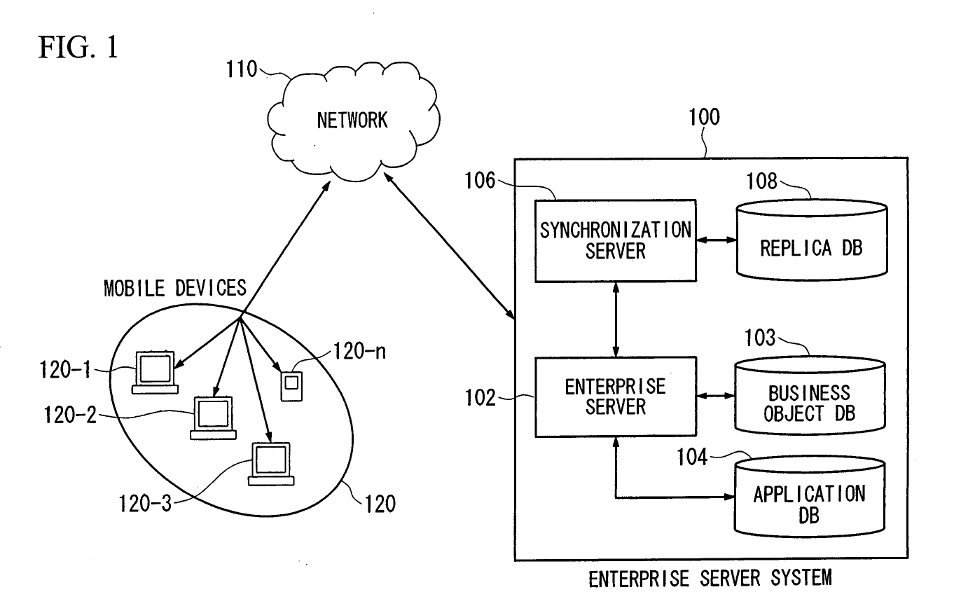

FIG. 1 is a structural diagram showing an enterprise server system in which a data synchronizer (referred to hereunder as a synchronization server) of the present embodiment is used. In the present embodiment, an enterprise server system 100 is constructed such that it is connected to a plurality of mobile devices (portable terminals) 120 via a network 110.

To be specific, the enterprise server system 100 comprises an enterprise server 102 and a synchronization server 106.

The enterprise server 102 has a business object database (referred to hereunder as DB) 103 and an application DB 104, and performs data communication administration between the mobile device 120, the business object DB 103 and the application DB 104.

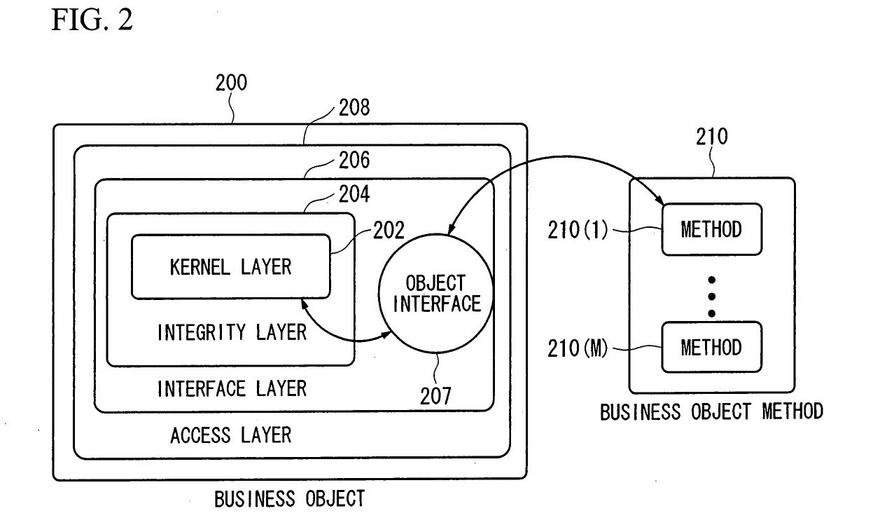

The business object DB 103 stores a plurality of business objects 200 as shown in FIG. 2. Here, a business object 200 is defined as an encapsulation of the properties associated with the enterprise server 102 and the business methods 210, and has a kernel layer 202, an integrity layer 204, an interface layer 206 and an access layer 208.

The kernel layer 202 comprises data (properties) associated with the business object 200 (to be described later). The integrity layer 204 performs data consistency checking based on environmental variable restrictions. The interface layer 206 defines a plurality of methods and interfaces containing an object interface 207 associated with the business object 200. The access layer 208 defines modules for accessing the business object 200.

The application DB 104 stores the application that the enterprise server 102 provides to the mobile device 120.

The synchronization server 106 contains a replica DB 108, and controls data synchronization between the mobile device 120, the business object DB 103 and the application DB 104. To be specific, the synchronization server 106 determines the data to be uploaded or downloaded between the mobile device 120, the business object DB 103 and the application DB 104, based on predetermined selection conditions (filter criteria), and performs data operations such as data creation, modification, deletion and the like, based on the reference relationships, referenced relationships (dependencies between data), cascade download flags, and the like, of data that match the selection conditions.

The replica DB 108 stores replica data, with the business objects stored in the business object DB 103 being the master data.

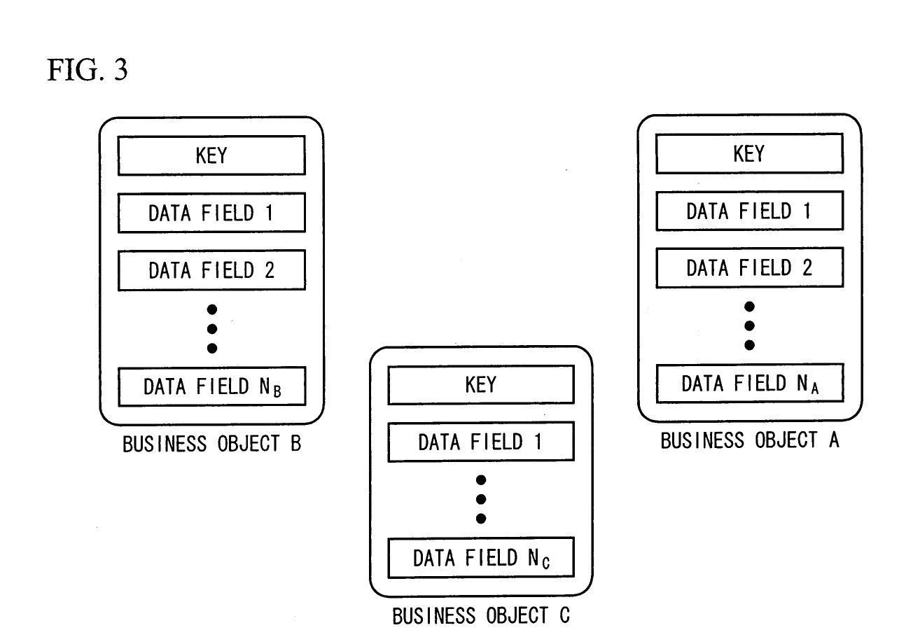

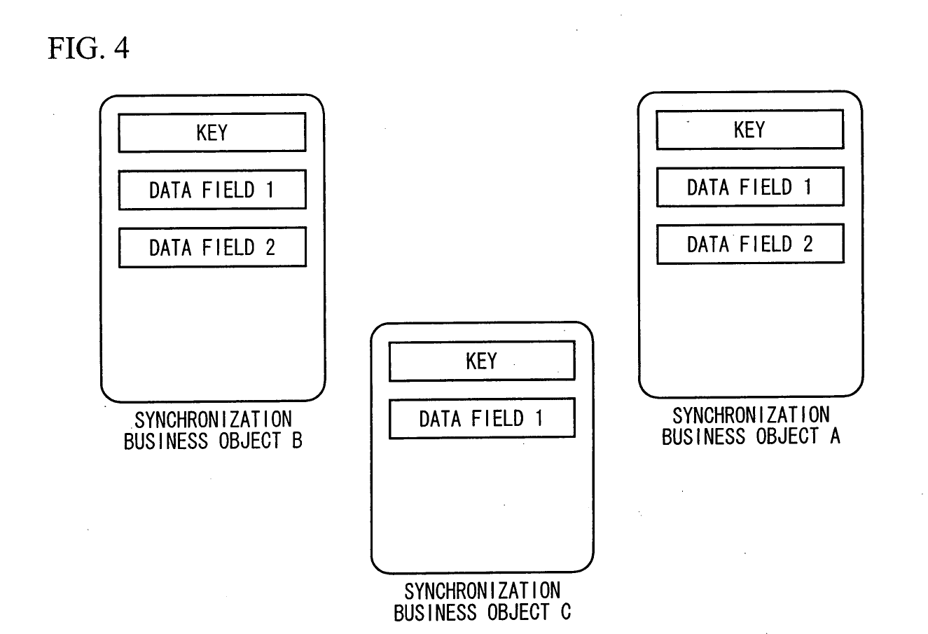

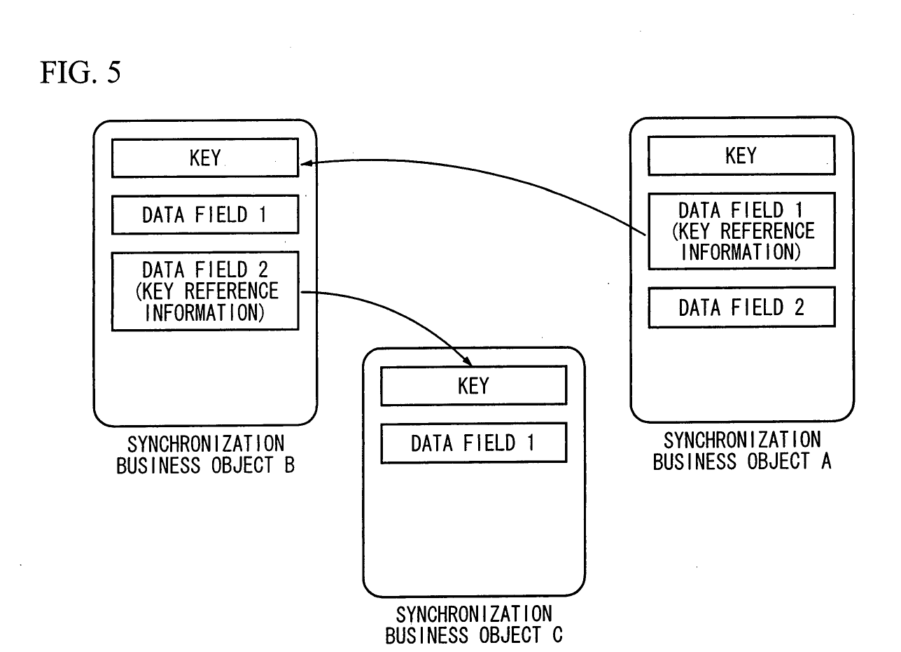

To be specific, business objects (A to B) stored in the business object DB 103 each comprise one key and a plurality of data fields as shown in FIG. 3, and have a redundant data field section for portable terminal users. Accordingly, if all of these redundant data fields are transmitted to the portable terminal, it puts pressure on the memory capacity of the portable terminal. Therefore, it is necessary to optimize the data transmitted.

For this reason, under data synchronizer control of the synchronization server 106, the replica DB 108 extracts only the necessary data fields from each of the business objects that match the selection conditions, and stores synchronization business objects A to C (referred to hereunder as sync BO) in which the data fields are substituted with business objects having reference relationships (to be described later).

Next is a description of the operation of the synchronization server 106 of the present embodiment with reference to the drawings. The synchronization server 106 of the present embodiment controls data synchronization between the mobile device 120, the business object DB 103 and the application DB 104. First is a description of cascade download processing as a type of data synchronization control, followed by a description of cascade deletion processing associated with a cascade downloaded sync BO.

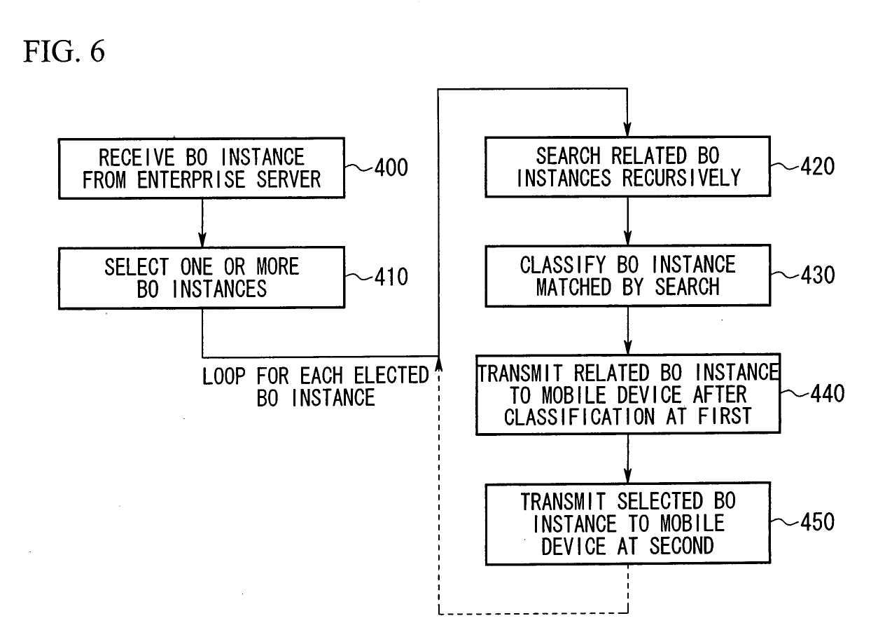

FIG. 6 is a flow chart showing the flow of the cascade download processing by the synchronization server 106 of the present embodiment.

When in the enterprise server 102, data in the business object 200 stored in the business object DB 103 and the application DB 104 are updated by addition, deletion, modification, or the like, the synchronization server 106 also receives the updated data into the replica DB 108.

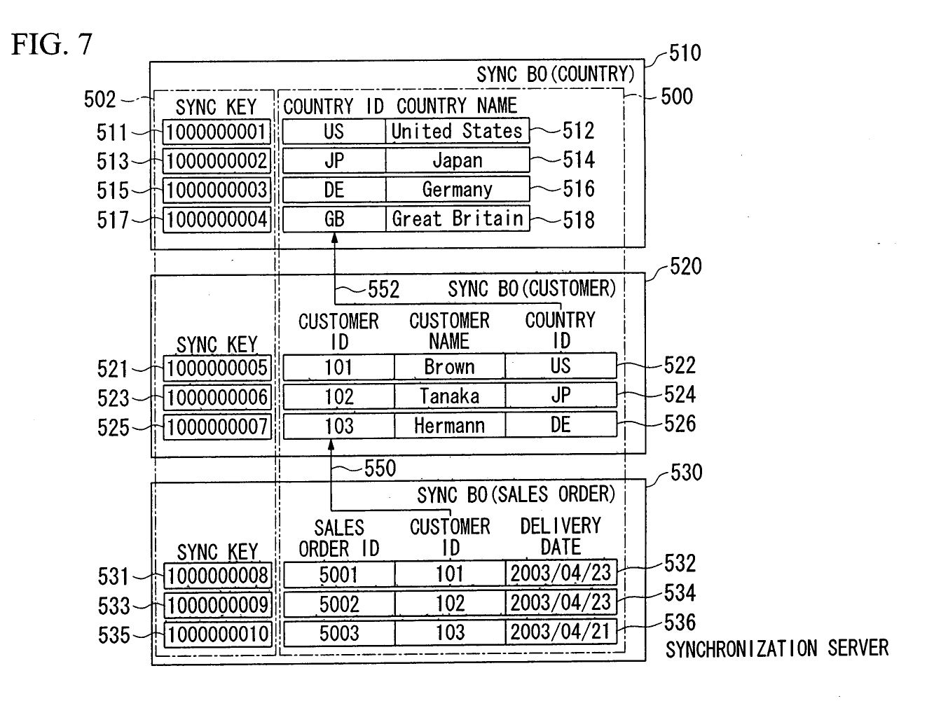

That is, as shown in FIG. 7, when an instance of a business object 200, of which type is “country,” “customer” or “sales order,” is received from the enterprise server 102 (step 400 of FIG. 6), the synchronization server 106 issues sync keys (key information for synchronization) to each sync BO, and stores them in the replica DB 108, linked to each of the instances received.

For example, in Sync BO 510 (Sync BO ID: 510), whose type is “country,” sync key 511, “1000000001” is issued and tied to the business object instance 512, in which the country ID is “US,” and the country name is “United States.” Similarly, sync keys 513, 515 and 517 are issued and tied to the business object instances 514, 516 and 518 respectively.

Furthermore, in Sync BO 520 (Sync BO ID: 520), whose type is “customer,” sync key 521, “1000000005” is issued and tied to the business object instance 522, in which the customer ID is “101,” the customer name is “Brown” and the country ID is “US.” Similarly, sync keys 523 and 525 are issued and tied to the business object instances 524 and 526 respectively.

Moreover, in Sync BO 530 (Sync BO ID: 530), whose type is “sales order,” sync key 531, “1000000008” is issued and tied to the business object instance 532, in which the customer ID is “101,” and the delivery data is “2003/04/23.” Similarly, sync keys 533 and 535 are issued and tied to the business object instances 534 and 536 respectively.

Here, as shown in FIG. 7, the data element “customer ID” of Sync BO 530 has a data reference relationship with the data element “customer ID” of Sync BO 520 (refer to arrow 550). Conversely, the data element “customer ID” of Sync BO 520 has a data referenced relationship with the data element “customer ID” of Sync BO 530.

Similarly, the data element “country ID” of sync BO 520 has a data reference relationship with the data element “country ID” of sync BO 510 (refer to arrow 552). Conversely, the data element “customer ID” of sync BO 510 has a data referenced relationship with the data element “country ID” of sync BO 520.

In the present specification, this data reference relationship and referenced relationship (dependency relationship and dependent relationship) between sync BOs is defined as a “parent-child relationship.”

Next, the synchronization server 106 searches the replica DB 108 based on predetermined selection conditions (which sync BO instance in the replica DB 108 is to be downloaded to which mobile device), and one or a plurality of instances is extracted as a list. Hereunder, an instance of an extracted sync BO is designated as an instance of a download candidate object.

The synchronization server 106 reads the list of these download candidate objects, and each instance of download candidate object is examined individually for data reference relationships/referenced relationships recursively.

Here, recursive examination of download candidate object means that in the case where a download candidate object, being a present examination object, has a data reference relationship/referenced relationship with other object data (not necessarily a download candidate object), the other object data is set as the object to be examined, and the data reference relationship/referenced relationship examination is repeated recursively.

That is, the synchronization server 106 first selects one instance of a download candidate object (step S420), examines data reference relationships in the parent direction, and searches for instances of corresponding object data (step S420).

For example, as shown in FIG. 7, a data element “customer ID: 101” of instance 532 has a reference relationship with a data element “customer ID: 101” of instance 522, and a data element “country ID: US” of instance 522 has a reference relationship with a data element “country ID: US” of instance 512. Therefore, in the case where instance 532 is selected as a download candidate object, the synchronization server 106 locates the data element “customer ID: 101” of instance 522, having a reference relationship with the data element “customer ID: 101.” Then, the synchronization server 106 searches recursively after designating instance 522 as the present examination object. In this case, the synchronization server 106 locates the data element “country ID: US” of instance 512, having a reference relationship with the data element “country ID: US.”

Next, the synchronization server 106 sorts instances 512 and 522, extracted as search results using the reference rules of instance 532, into descending order (or ascending order) by the hierarchical levels of the reference relationships (step S430). In the case of sorting into descending order, the instances of the download candidate objects are rearranged from instance 512, defined as the highest rank in the parent direction in the reference relationship hierarchical levels, to instances 522 and 532 in the child direction.

Then, the synchronization server 106 transmits firstly instances 512 and 522, being cascade download objects, to the mobile device 120 in this order (step S440). After completing transmission of these cascade download object instances, the synchronization server 106 transmits the instance 532 originally selected as a download candidate object to the mobile device 120 (step S450).

In this manner, after transmitting the other instances having referenced relationships, the synchronization server 106 transmits the instance having the reference relationship to the mobile device. Thus, an effect can be obtained in which data errors wherein there is no reference data in the memory of the mobile device 120 can be prevented from occurring.

Similarly, in the case where instance 534 is selected (step S410), instances 524 and 514 are extracted (step S420) as search results, rearranged into descending order (step S430), and after completing transmission processing of instances 514 and 524, being cascade download objects having referenced relationships (step S440), the instance 534 is transmitted and processed as a download candidate object.

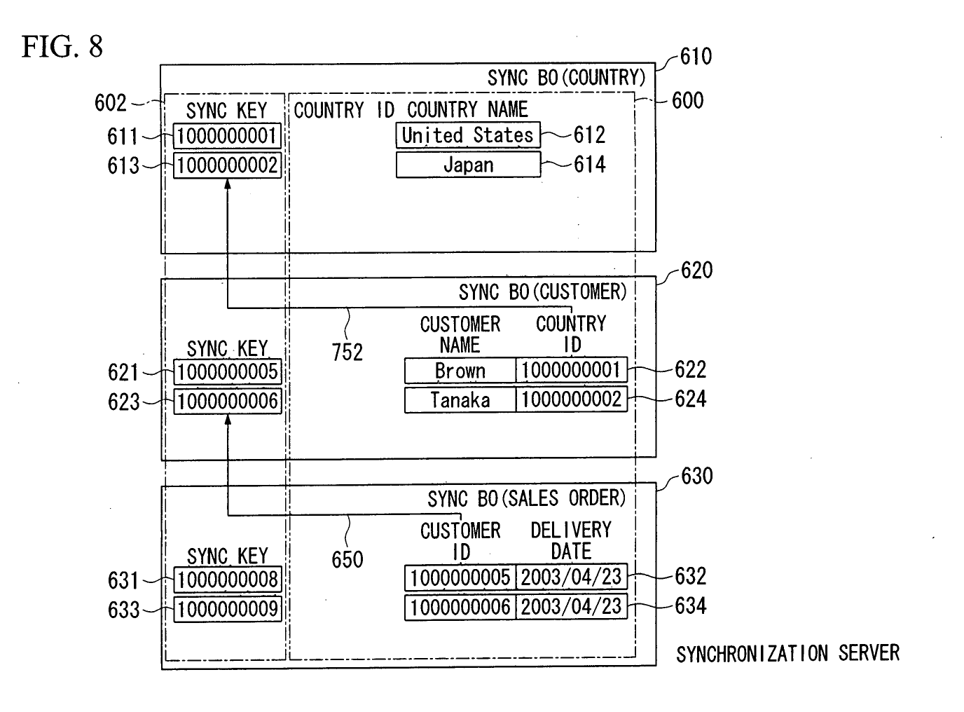

FIG. 8 shows object data, which are extracted from the replica DB 108 and transmitted to the mobile device 120.

In the replica DB 108, instances 512, 514, 516, 518, 522, 524, 526, 532, 534 and 536 are identified using uniform sync keys 511, 513, 515, 517, 521, 523, 525, 531, 533 and 535 respectively. Therefore, the data elements “customer ID” of instances 532 and 534 are substituted by sync keys 521 and 523 (corresponding to sync keys 621 and 623 shown in FIG. 8), and the data elements “country ID” of instances 522 and 524 are substituted with sync keys 511 and 513 (corresponding to sync keys 611 and 613 shown in FIG. 8).

As a result, it is possible to extract the minimum number of instances necessary while maintaining the reference relationships/referenced relationships between data objects. Thus, it is possible to obtain an effect whereby transmitted data can be optimized.

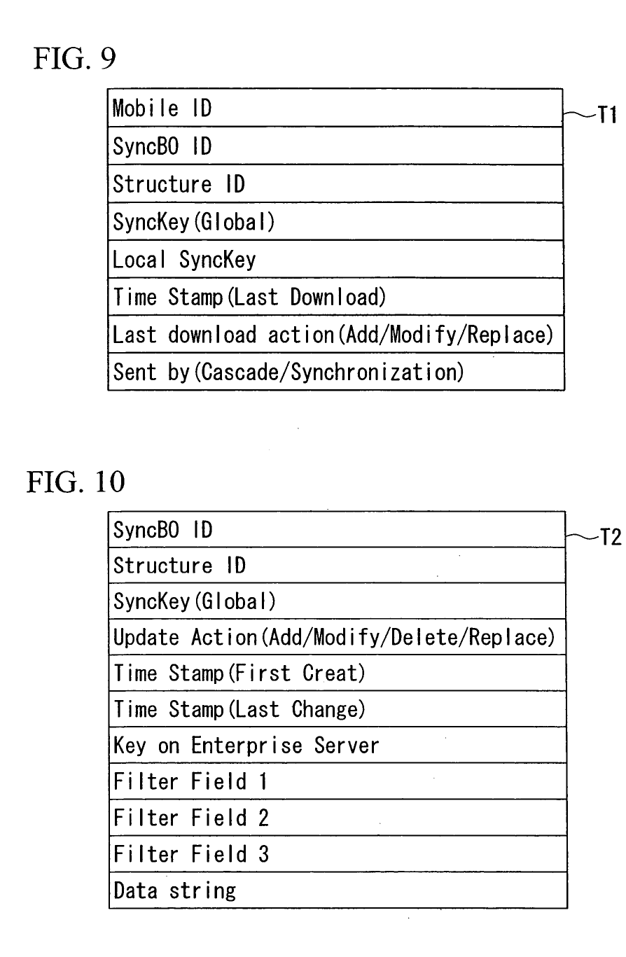

The search results of the above-described substitution operation, and data reference relationships/referenced relationships, are stored in administration tables T1 to T3, as shown in FIG. 9 to FIG. 11, in the synchronization server 106, and referenced at the time of cascade deletion as described later.

FIG. 9 is a status administration table T1 for each instance.

Each instance is identified by the identifier (Mobile ID) of the sending address of a mobile device, the identifier (Sync BO ID) of a sync BO, and a sync key (SyncKey), and each data element stored by each instance is identified by the structure identifier (Structure ID) of the corresponding instance. For example, in a mobile device 120, the data elements of instance 632, being customer ID, “1000000005,” and delivery data “2003/04/23,” are identified by the combination of sync key and structure identifier.

There are three types of identifier in each instance. Each instance is identified uniquely by an enterprise server key (Key on Enterprise Server) in the enterprise server 102. Furthermore, each instance is identified uniquely by a sync key (global sync key), which is issued and administered in the synchronization server 106 independently from the mobile device. Moreover, each instance is identified uniquely by the combination of mobile ID and mobile device dependent sync key (local sync key) in the mobile device 120.

The synchronization server 106 uses the three types of instance identifier in different ways depending on the access address (the business object DB 103 and the application DB 104 of the enterprise server 102, the replica DB 108 of the synchronization server 106 and the mobile device 120).

That is, when the synchronization server 106 accesses an instance stored in the business object DB 103 and the application DB 104, it specifies the instance using an enterprise server key.

Furthermore, when the synchronization server 106 accesses an instance stored in the replica DB 108, it specifies the instance using a global sync key.

Moreover, when the synchronization server 106 accesses an instance stored in the mobile device 120, it specifies the instance using a mobile ID and a local sync key.

Furthermore, in the case where there is a reference and referenced relationship between instances, similarly, the synchronization server 106 uses the above-described three types of identifier as identifiers to link the reference instance and referenced instance.

Instances 511 to 535 are stored in the “Data String” field of table T2 as shown in FIG. 10, and a relationship is defined in advance between sync BO (sales order) 530 and sync BO (customer) 520 with the “customer ID” field as an external key.

To be specific, the customer ID of instance 531 has a value “101” as an enterprise server key, and similarly, the field “customer ID” of instance 521 has the same value “101” as the customer ID of instance 531. Thus a reference and referenced relationship is established between instances 521 and 531.

In the mobile device 120, this reference and referenced relationship is maintained by the synchronization server 106 by converting the value of the field customer ID from “101,” being the enterprise server key, to “1000000005,” being the sync key, when downloading instance 531 (refer to instance 631).

Here, only in the case where an instance is newly registered in the mobile device 120, a value is allocated to a local sync key, which is taken from a range of numbers defined exclusively for each mobile device 120. The instance, which is linked to the local sync key allocated in the mobile device 120, is allocated a global sync key at the time of data registration to the synchronization server 106, and afterwards, similarly, is identified uniquely using any combination of the enterprise server key, the global sync key, the mobile ID and the local sync key.

Thus, it is possible to obtain an effect whereby the mobile device 120 can identify and administer each instance by a combination of a mobile ID and a local sync key, with no limitation to the range in which global sync keys administered by the synchronization server 106 can be allocated.

The synchronization server 106 obtains the above identification information from each object data when searching reference relationships, and stores a time stamp when performing the update download process, the type (addition, modification, deletion, reset) of update download process, and “true/false” (On/Off) cascade download flag indicating the existence or nonexistence of cascade download processing in table T1.

Furthermore, the synchronization server 106 administers time stamps for the time of creation of the data elements involved, time stamps for the final update history, data column (Data String) and selection conditions (Filter Fields 1 to 3) associated with each sync BO, in a state administration table T2 for each instance, as shown in FIG. 10.

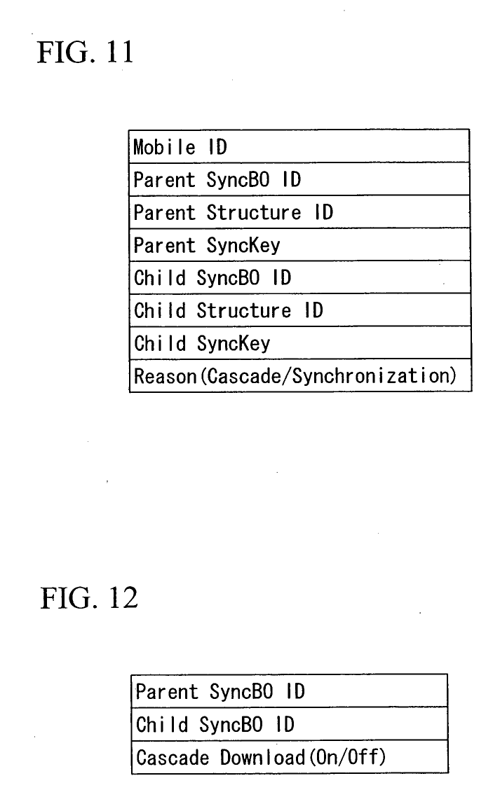

Moreover, the synchronization server 106 defines and administers the relationships between the combinations of parent sync BO (Parent SyncBO), sync key (Parent SyncKey) and structure identifier (Parent Structure ID), and the combinations of child sync BO (Child SyncBO), sync key (Child SyncKey) and structure identifier (Child Structure ID), respectively, as parent-child relationships of object data stored in the mobile device involved for each data reference relationship/referenced relationship described above, in a state administration table T3 for each instance, as shown in FIG. 11.

Furthermore, the arrangement may be such that the synchronization server 106 sets the cascade download process enable/disable as required for every combination of parent-child relationship defined between data objects, in an administration table T4 as shown in FIG. 12.

Using the above cascade download process in an enterprise server system in which a synchronization server of the present embodiment is used, it is possible to reduce the amount of data transmitted to the mobile device, and it is also possible to prevent data errors in the mobile device.

Next is a description of a cascade deletion process associated with a cascade downloaded sync BO.

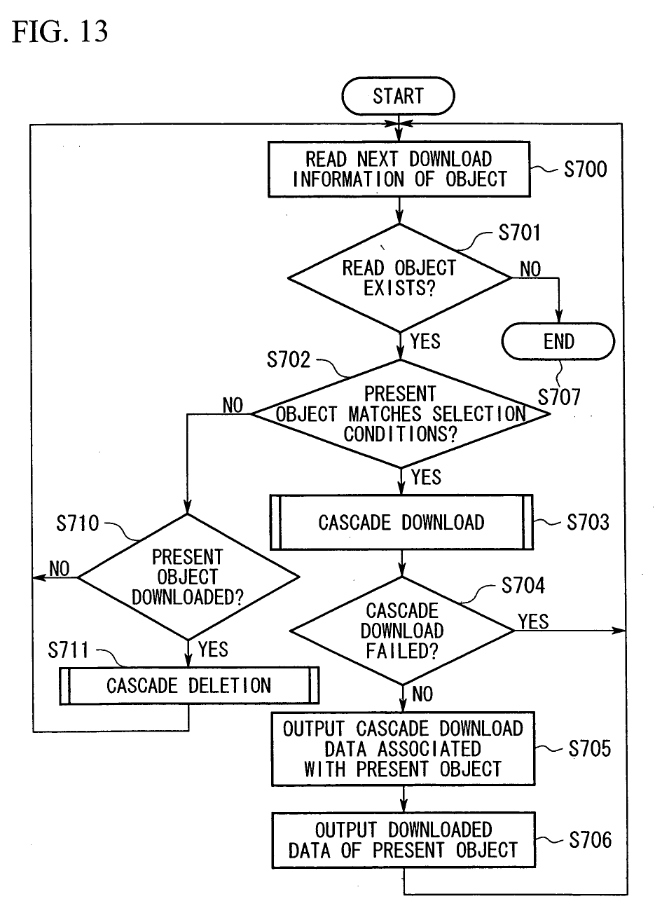

FIG. 13 is a flow chart showing the flow of the main processes of cascade download and cascade deletion by a synchronization server 106 of the present embodiment.

When the above-mentioned cascade download process is executed (steps S700 to S703 of FIG. 13), the synchronization server 106 outputs cascade download data (refer to tables T1 to T4) associated with the object data, being the present object to be processed (step S705), and outputs download data associated with the object data, being the present object to be processed, each time a cascade download process is completed (Yes in step S704).

The download data contains all of the data downloaded by cascade download, and the data downloaded when triggered by matching selection conditions.

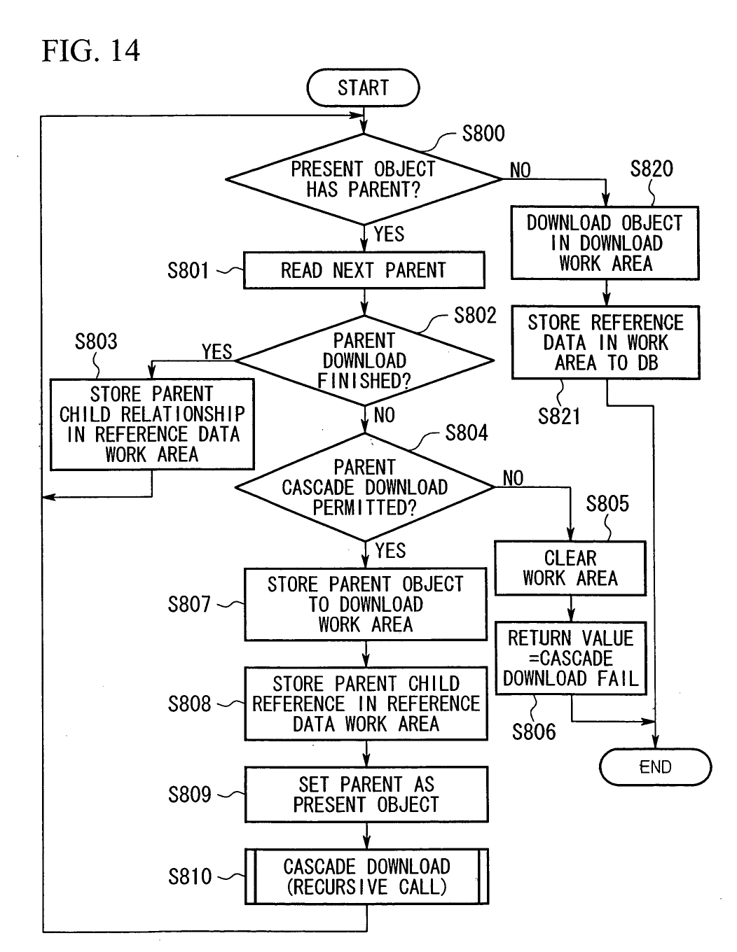

The flow of this process will be explained using the flow chart of FIG. 14. In step S703, when the cascade download process is called, the synchronization server 106 determines whether there is parent object data or not in the object data, being the present object to be processed, by firstly checking the existence or nonexistence of parent sync key and structure identifier fields in the state administration table T1 (step S800 of FIG. 14).

In the case where there is parent object data (Yes in step S800), the synchronization server 106 reads the parent object data (step S801).

In the case where it is determined by examining the state administration table T2 of the parent object data read that the object data has been downloaded into the mobile device 120 (Yes in step S802), the synchronization server 106 stores, temporarily, the parent-child relationship of the object data, being the original object to be processed, and the parent object data read, in a reference data work area allocated in the memory (step S803).

In the case where it is determined that the parent object data read has not been downloaded into the mobile device 120, the synchronization server 106 examines the administration table T4 again, and determines whether cascade download is enabled or not (step S804).

In the case where cascade download is not enabled for the parent object data (No in step S804), the synchronization server 106 clears the work area (step S805), returns a message indicating that the cascade download process failed (step S806), and the process is terminated.

On the other hand, in the case where cascade download is enabled for the parent object data, the synchronization server 106 stores this object data in a work area for download allocated in the memory (step S807) temporarily, and also stores, temporarily, the parent-child relationship of the object data, being the original object to be processed, and the parent object read, in a reference data work area allocated in the memory (step S808).

After the object data is stored in the work area for download, and the reference data showing the parent-child relationship is stored in the reference data work area, the synchronization server 106 sets the object to be processed as the parent object data (step S809), and calls the cascade download process recursively (step S810). As a result, the processing routine of steps S800 to 810 is repeated, and when the present object data has no parent object data (No in step S800), it exits the routine, the object data stored in the work area for download at the point of time involved is downloaded into the mobile device 120 (step S820), and the reference data stored in the reference data work area is stored in tables T1 to T4 in the replica DB 108 (step S821).

Then, when the sync BO is updated periodically, in the case where the selection conditions are updated, the synchronization server 106 performs data synchronization control between the mobile device 120, the business object DB 103 and the application DB 104, again, and the cascade download process is performed as required.

That is, the synchronization server 106 reads the list of download candidates of objects as described above (step S700), and if there is an object to be read (Yes in step S701), it is determined whether the present object to be processed matches the selection conditions after update or not (step S702).

Then, in the case where the present object to be processed does not match the selection conditions after update, the synchronization server 106 determines whether this object has been downloaded into the mobile device 120 in the past or not (or whether it has been deleted after download or not) (step S710), by comparing the present time and the time stamp of when the latest download process was performed, and examining the type (addition, modification, deletion, reset) of the latest download process.

When it is confirmed from the result of the determination that the object data, which does not match the selection conditions after update, has been downloaded into the mobile device 120, the synchronization server 106 starts the cascade deletion process.

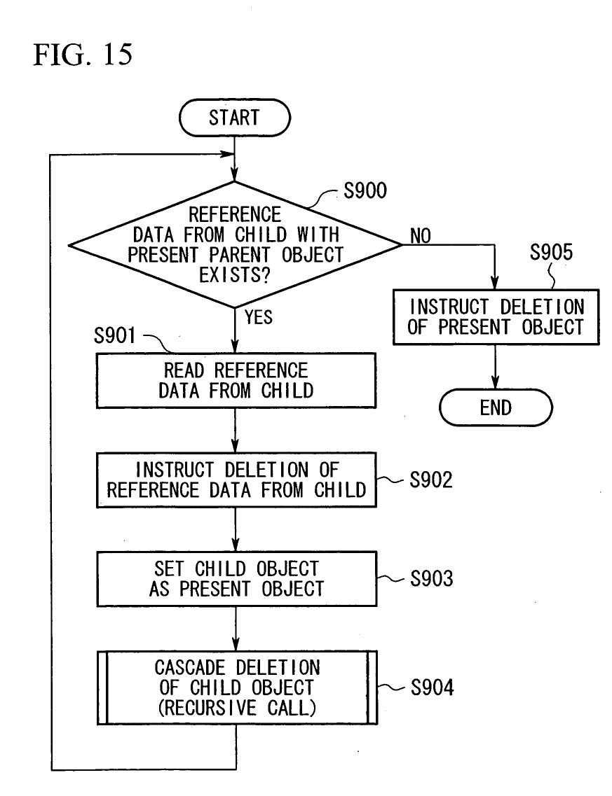

The flow of this process will be described using the flow chart of FIG. 15. When the cascade deletion process is called in step S711, the synchronization server 106 determines by the existence or nonexistence of child object data whether the object data, being the present object to be processed and an object to be deleted among a plurality of object data stored in the portable terminal, is referenced by other object data or not, and outputs an instruction to delete the object data, being the object to be deleted, to the portable terminal based on the determination result.

That is, the synchronization server 106 determines the existence or nonexistence of child object data (step S900 of FIG. 15) by checking the existence or nonexistence of the child sync key and structure identifier fields in the state administration table T3 in which the object data, being the present object to be processed, are the parent sync key and structure identifier.

In the case where there is child object data in the state administration table T3 (Yes in step S900), the synchronization server 106 reads the object data of this child (step S901). Then, the synchronization server 106 deletes reference data from the child object data to the object data, being the present object to be processed, from the state administration table T3 (step S902).

After deleting the reference data, the synchronization server 106 sets the child object data as the object to be processed (step S903), and calls the child object cascade deletion process (step S904) recursively. As a result, the processing routine of steps S900 to 904 is repeated, and when the present object data has no child object data (No in step S900), it exits the routine, and an instruction is performed to delete the object data, being the present object to be processed (object to be deleted) (step S905).

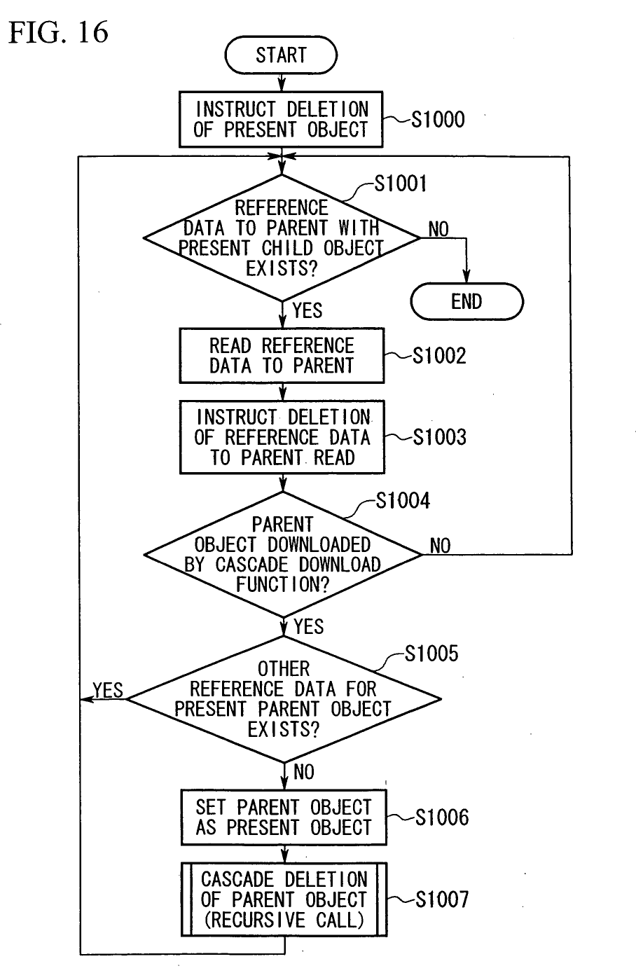

That is, the synchronization server 106 outputs an instruction to delete the object data, being the present object to be processed (object to be deleted), to the corresponding mobile device 120 (step S1000 of FIG. 16).

Then, the synchronization server 106 determines by the existence or nonexistence of parent object data whether the object data, being the present object to be processed and an object to be deleted among a plurality of object data stored in the portable terminal, references other object data or not, and outputs an instruction to delete the object data, being the object to be deleted, to the portable terminal based on the determination result.

That is, the synchronization server 106 searches the state administration table T3 in which the object data, being the present object to be processed, are the child sync key and structure identifier, and if there is a corresponding table, by further determining the existence or nonexistence of the parent sync key and structure identifier fields in the table involved, it determines the existence or nonexistence of child object data (step S1001).

In the case where there is parent object data in the state administration table T3 (Yes in step S1001), the synchronization server 106 reads the object data of this parent (step S1002). Then, the synchronization server 106 deletes reference data from the parent object data to the object data, being the present object to be processed, from the state administration table T3 (step S1003).

After deleting the reference data, the synchronization server 106 examines a cascade download flag, which is set at the time of cascade download, for the parent object data having a reference relationship with the object data, being the present object to be processed, and determines whether the parent data object is the object data that was cascade downloaded (step S1004).

In the case where the parent object is the object data that was cascade downloaded, the synchronization server 106 further determines whether the parent object data is referenced by other object data or not.

That is, the synchronization server 106 searches other state administration tables T3 in which the parent object data are the parent sync key and structure identifier, and if there is a corresponding table, determines the existence or nonexistence of child object data (step S1005) by checking the existence or nonexistence of the child sync key and structure identifier fields in that table.

In the case where there is no corresponding other state administration table T3 (No in step S1005), the parent object data selected for download by the cascade download process is unnecessary, and would put pressure on the memory capacity of the mobile device 120. Therefore, the synchronization server 106 sets the parent object data having a reference relationship as the object to be processed (object to be deleted) (step S1006), and calls the parent object cascade deletion process recursively (step S1007).

As a result, the processing routine of steps S1001 to 1007 is repeated, and when the present data has no parent object data (No in step S1001), it exits the routine, and the cascade deletion process is terminated.

Using the cascade deletion process above in an enterprise server system in which a synchronization server of the present embodiment is used, it is possible to obtain an effect whereby data to be deleted is selected appropriately, and deleted considering the existence or nonexistence of a cascade download process, and the necessity of the data based on reference/referenced relationships between object data stored in the memory of the mobile device 120.

Accordingly, it is possible to use the memory region of the mobile device 120 effectively. Therefore, it is possible to obtain an effect whereby the cost of hardware such as memory and the like can be reduced.

In the present embodiment, an example is shown in which the child object cascade deletion process is called recursively in step S904 of FIG. 15, and the number of loops is not mentioned specifically. However, the present invention is not limited to this, and the recursive calling of the child object cascade deletion process may be limited to a fixed number or fewer from the point of view of installation efficiency. In this case, the synchronization server 106 sets, in advance, the classification and directionality of matching BO instances in the search of step S430 shown in FIG. 6, in a fixed direction, from the upstream direction (parent object) to the downstream direction (child object) for example, based on the reference and referenced relationships of the BO instance.

In step S711 of FIG. 13, when the cascade deletion process is called, the synchronization server 106 performs the cascade deletion process of step S900 to step S904 of FIG. 15 similarly, and afterwards, calls the child object cascade deletion process recursively. At this time, the synchronization server 106 counts the number of recursive calls of the child object cascade deletion process. Here, the number of recursive calls is incremented by 1, and the number of recursive calls, 1, is stored in a memory space allocated to the cascade deletion process.

In step S904, when the cascade deletion process is called recursively, the synchronization server 106 repeats step S900 to step S902 of FIG. 15. Then, after performing the cascade deletion process in step S902, the synchronization server 106 checks the limit of the number of recursive calls of the child object cascade deletion process written in the memory, and if it does not exceed the limit, the child object cascade deletion process is called recursively (steps S903 and S904). On the other hand, if it exceeds the limit, the child cascade deletion process is not called recursively.

Accordingly, for example, if the limit of recursive calls of the child object cascade deletion process is set to 1, it is possible to obtain an effect whereby the loop process time and system resource can be reduced.

Furthermore, even if the number of recursive calls of the child object cascade deletion process is limited in this manner, by repeated recursive calls of the parent object cascade deletion process, it is possible to obtain an effect whereby all objects to be deleted can be selected similarly to the case where there is no limit to the number.

The above-described enterprise server 102, synchronization server 106 and mobile device 120 contain computer systems.

The flow of the series of processes associated with the above-described cascade download process and cascade deletion process are stored in a computer readable recording medium in the form of a program, and the above processes are performed by reading and executing this program on a computer.

That is, each of the processing devices and processing sections in the enterprise server 102, the synchronization server 106, and the mobile device 120 is realized by a central processing unit such as a CPU or the like by reading the above-described program into a main memory such as a RAM or the like, and performing information processing and calculation processing.

Here, computer readable recording medium means a magnetic disk, a magneto-optical disk, CD-ROM, DVD-ROM, semiconductor memory, or the like. Furthermore, the arrangement may be such that this computer program is delivered to a computer by a communication line, and the computer to which it is delivered executes the program.

As described above, the present invention determines whether there are reference relationships/referenced relationships for an object to be deleted in other object data among a plurality of object data stored in a portable terminal, and outputs an instruction to the portable terminal to delete the object data. Therefore, it is possible to obtain an effect whereby data can be synchronized efficiently between database systems and portable terminals.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A data synchronizing control apparatus connectable to a portable device via a network, comprising:
a reference relationship determination device determining whether or not object data to be deleted is referenced by other object data among a plurality of object data stored in said portable device and
a data deletion device outputting, to said portable device, an instruction to delete said object data to be deleted, based on the determination result of said reference relationship determination device.

2. The data synchronizing control apparatus according to claim 1, wherein in the case where the determination result of said reference relationship determination device indicates that said object data to be deleted is not referenced by other object data, said data deletion device outputs an instruction to said portable device to delete said object data to be deleted.

3. The data synchronizing control apparatus according to claim 1, wherein in the case where the determination result of said reference relationship determination device indicates that said object data to be deleted is referenced by other object data, said data deletion device sets the other object data having said reference relationship as the object to be deleted, and calls said reference relationship determination device recursively.

4. A data synchronizing control apparatus connectable to a portable terminal via a network, comprising:
a reference relationship determination device determining whether or not object data to be deleted references other object data among a plurality of object data stored in said portable terminal; and
a data deletion device outputting to said portable terminal, an instruction to delete the other object data referenced by said object data to be deleted references, based on the determination result of said reference relationship determination device.

5. The data synchronizing control apparatus according to claim 4, wherein in the case where the determination result of said reference relationship determination device indicates that said object data to be deleted references no other object data, said data deletion device outputs an instruction to said portable terminal to delete said object data to be deleted.

6. The data synchronizing control apparatus according to claim 4, wherein in the case where the determination result of said reference relationship determination device indicates that said object data to be deleted references other object data, said data deletion device sets the other object data having said reference relationship as the object to be deleted, and calls said reference relationship determination device recursively.

7. The data synchronizing control apparatus according to claim 4, wherein in the case where the determination result of said reference relationship determination device indicates that said object data to be deleted references other object data, said data deletion device examines a cascade download flag, which is preset in the other object data having said reference relationship, and based on the examination result, sets the other object data having said reference relationship as the object to be deleted, and calls said reference relationship determination device recursively.

8. The data synchronizing control apparatus according to claim 4, wherein in the case where the determination result of said reference relationship determination device indicates that the object data to be deleted references other object data, said data deletion device examines a cascade download flag, which is preset in the other object data having said reference relationship, determines whether said object data is referenced by other object data or not, and based on said examination result and determination result, sets the other object data having said reference relationship as the object to be deleted, and calls said reference relationship determination device recursively.

9. A method for synchronizing data in a data synchronizing control apparatus connectable to a portable device via a network, comprising:
determining whether or not object data to be deleted is referenced by other object data among a plurality of object data stored in said portable device; and
outputting an instruction to said portable terminal to delete said object data to be deleted based on the determination result.

10. The data synchronizing method according to claim 9, further comprising, in the case where the determination result of said reference relationship indicates that said object data is not referenced by the other object data, outputting an instruction to said portable device to delete said object data to be deleted.

11. The data synchronizing method according to claim 9, further comprising, in the case where the determination result of said reference relationship indicates that said object data is referenced by the other object data, setting the other object data having the reference relationship as the object to be deleted, and recursively calling a reference relationship determination step which determines said reference relationship.

12. A method for synchronizing data in a data synchronizing control apparatus connectable to a portable terminal via a network, comprising:
determining whether or not object data to be deleted references other object data among a plurality of object data stored in said portable terminal; and
outputting an instruction to said portable terminal to delete the other object data which said object data to be deleted references, based on the determination result.

13. The data synchronizing method according to claim 12, further comprising, in the case where the determination result of said reference relationship indicates that said other object data is not referenced, outputting an instruction to said portable terminal to delete said object data to be deleted.

14. The data synchronizing method according to claim 12, further comprising, in the case where the determination result of said reference relationship indicates that said other object data is referenced, setting the other object data having said reference relationship as the object to be deleted, and recursively calling a reference relationship determination step which determines said reference relationship.

15. The data synchronizing method according to claim 12, further comprising, in the case where the determination result of said reference relationship indicates that said other object data is referenced, examining a cascade download flag, which is preset in the other object data having said reference relationship, and based on the examination result, setting the other object data having said reference relationship as the object to be deleted, and recursively calling a reference relationship determination step which determines said reference relationship.

16. The data synchronizing method according to claim 12, further comprising, in the case where the determination result of said reference relationship indicates that said other object data is referenced, examining a cascade download flag, which is preset in the other object data having said reference relationship, determining whether the object data is referenced by the other object data or not, and based on said examination result and determination result, setting the other object data having said reference relationship as the object to be deleted, and recursively calling a reference relationship determination step which determines said reference relationship.

17. A computer-readable medium on which is stored a set of instructions for synchronizing data for a data synchronizing control apparatus connectable to a portable device via a network, which instructions when executed perform stages comprising:
determining whether or not object data to be deleted is referenced by other object data among a plurality of object data stored in said portable device; and
outputting an instruction to said portable device to delete said object data to be deleted based on the determination result of said reference relationship.

18. The computer-readable medium, according to claim 17, wherein the performed stages further comprise, in the case where the determination result of said reference relationship indicates that said object data is not referenced by said other object data, outputting an instruction to said portable device to delete said object data to be deleted.

19. The computer-readable medium, according to claim 17, wherein the performed stages further comprise, in the case where the determination result of said reference relationship indicates that said object data is referenced by said other object data, setting the other object data having said reference relationship as the object to be deleted, and recursively determining said reference relationship.

20. A computer-readable medium on which is stored a set of instructions for synchronizing data for a data synchronizing control apparatus connectable to a portable terminal via a network, which instructions when executed perform stages comprising:
determining whether or not object data to be deleted references other object data among a plurality of object data stored in said portable terminal; and
outputting an instruction to said portable terminal to delete the other object data that the object data to be deleted references based on the determination result of the reference relationship.

21. The computer-readable medium according to claim 20, wherein the performed stages further comprise, in the case where the determination result of said reference relationship indicates that said other object data is not referenced, outputting an instruction to said portable terminal to delete said object data to be deleted.

22. The computer-readable medium according to claim 20, wherein the performed stages further comprise, in the case where the determination result of said reference relationship indicates that said object data is referenced by said other object data, setting the other object data having said reference relationship as the object to be deleted, and recursively determining said reference relationship.

23. The computer-readable medium according to claim 20, wherein the performed stages further comprise, in the case where the determination result of said reference relationship indicates that said other object data is referenced, examining a cascade download flag, which is preset in the other object data having said reference relationship, and based on the examination result, setting the other object data having said reference relationship as the object to be deleted, and recursively determining said reference relationship.

24. The computer-readable medium according to claim 20, wherein the performed stages further comprise, in the case where the determination result of said reference relationship indicates that the other object data is referenced, examining a cascade download flag, which is preset in the other object data having said reference relationship, determining whether said object data is referenced by the other object data or not, and based on said examination result and determination result, setting the other object data having said reference relationship as the object to be deleted, and recursively determining said reference relationship.
